(19) United States
(12) Patent Application Publication
(10) Pub. No.: US 2005/0189795 A1
(43) Pub. Date: Sep. 1, 2005

(54) Phosphorescent sunroof

(76) Inventor: David Martyn Roessler, Hazel Park, MI (US)

Correspondence Address: KATHRYN A MARRA;General Motors Corporation, Mail Code 482-C23-B21, Legal Staff, P.O. Box 300, Detroit, MI, 48265-3000, US

(21) Appl. No.: 10/788,927

(22) Filed: Feb. 27, 2004

(51) Int. Cl. B60J 7/043

(52) U.S. Cl. 296/215

(57) ABSTRACT

A phosphorescent sunroof for transmitting light into a vehicle includes a roof assembly comprising a roof having an opening, and a panel adapted to fit the dimensions of the opening. The panel is made of a light-transparent component that transmits light from an external source into the vehicle. The panel includes a phosphorescent material that is excited or made to glow by the external light source without the use of vehicle power. The panel glows for a period of time following exposure to the external light source to allow visibility inside the vehicle and provide aesthetic qualities. Further, the phosphorescent material scatters or diffuses incident light transmitted through the panel, thereby reducing the direct radiation of light and heat load into the vehicle. Also disclosed is a method for providing light into an interior of a vehicle with the sunroof panel.

### BACKGROUND

The present disclosure relates to a sunroof panel for a vehicle, and more particularly, to a sunroof panel containing a phosphorescent material that is energized without the use of electrical power.

It is known in the art of vehicle roofs to provide a sunroof panel within the roof wall to allow for the transmission of light into the vehicle. Although these panels can provide enhanced visibility and a feeling of spaciousness within the vehicle, the light entering the vehicle is usually dependent on an external light source. In the absence of an external light source, such as at night, these benefits may not be readily achieved without the use of an additional power source.

As a sunroof panel transmits light into a vehicle, the heat load in the vehicle may increase. The heat load may increase, particularly when the vehicle is slow-moving or parked, and cause discomfort to the passengers, and damage to various components or parcels within the vehicle. As a result, sunroof panels may include a material such as a tint or a liquid crystal to help diffuse or reduce the transfer of thermal radiation into the vehicle. However, in the absence of an external light source, these materials may not provide enhanced visibility. Radioluminescent materials may be added to the sunroof panel to enhance visibility, however these materials pose environmental concerns.

### BRIEF SUMMARY

Disclosed herein is a sunroof panel for an opening, the sunroof panel being adapted to fit a dimension of the opening. The sunroof panel comprises a phosphorescent material and a light-transparent component.

In accordance with another embodiment, a vehicle sunroof assembly comprises a vehicle roof portion having at least one opening, said opening extending between an interior portion and an exterior portion of the vehicle roof portion; and a sunroof panel adapted to fit the at least one opening, said panel comprising a phosphorescent material and a light-transparent component.

Also disclosed is a method for providing light into an interior of a vehicle, comprising exposing a panel disposed in an opening of the vehicle to an external light source, wherein the panel comprises a phosphorescent material and a light-transparent component; absorbing radiant energy from the external light source to excite electrons in the phosphorescent material; and emitting visible light from the phosphorescent material and into the interior of the vehicle upon exposure to the external light source or upon discontinuation of the external light source.

The above described and other features are exemplified by the following figures and detailed description.

### BRIEF DESCRIPTION OF THE DRAWINGS

Referring now to the figures, which are meant to be exemplary embodiments, and wherein the like elements are numbered alike.

FIG. 1 is a general perspective view of a sunroof panel in accordance with the present invention.

FIG. 2 is a cross-sectional view of a sunroof panel with phosphorescent material dispersed within light-transparent material in accordance with the present invention.

FIG. 3 is a view of an edge of a sunroof panel in accordance with the present invention.

FIG. 4 is a simplified schematic of a roof assembly in accordance with the present invention.

### DETAILED DESCRIPTION OF THE PREFERRED EMBODIMENT

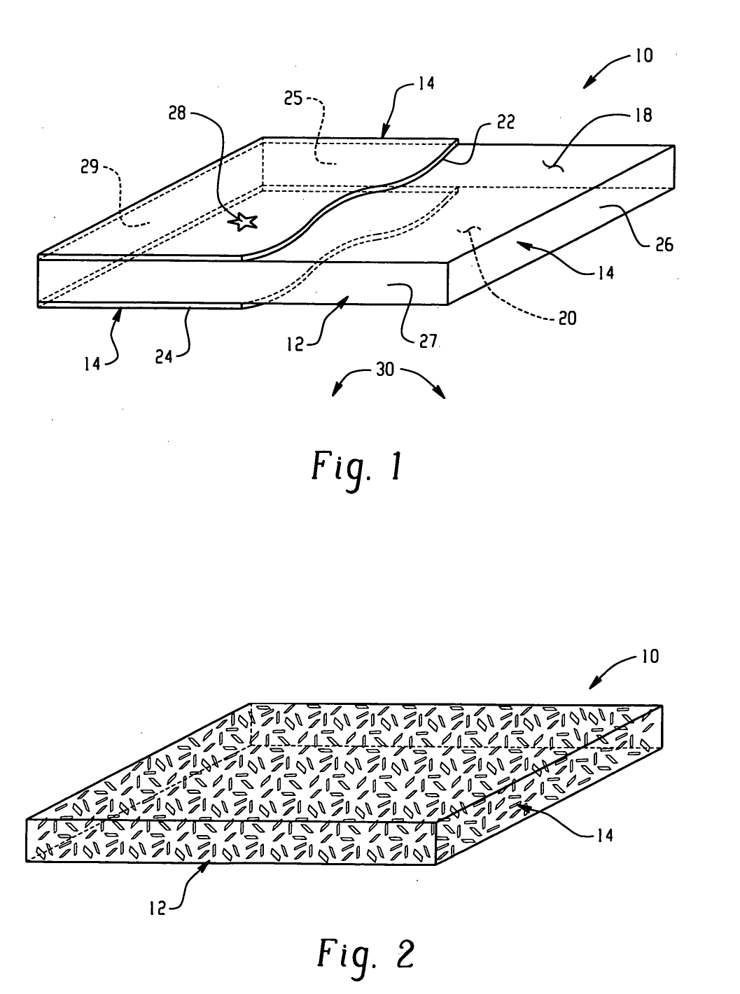

Referring now to FIG. 1, there is depicted a sunroof panel generally designated as reference numeral 10 for a vehicle having a roof with an opening. The sunroof panel 10 generally includes a light-transparent component 12 and a phosphorescent material 14. The phosphorescent material 14 may be dispersed within a matrix of the light-transparent component 12 or located on a surface 18 and/or 20 of the light-transparent component 12. As the sunroof panel 10 is exposed to an external light source, the phosphorescent material 14 absorbs radiant energy from the external light source and electrons in the material become excited. In this excited state, the phosphorescent material 14 exhibits a glowing light discharge for a period of time determined by a decay of the electrons in the excited state. The glowing light discharge is preferably at a wavelength within the visible light spectrum, i.e., wavelengths of about 400 nanometers to about 700 nanometers (nm).

The light-transparent component 12 preferably comprises a material capable of transmitting light and providing sufficient rigidity to function as a sunroof panel. Moreover, the light-transparent component should be suitable for use in the intended environment, i.e., weather resistant. Suitable light-transparent components 12 are comprised of materials known to those skilled in the art and include glass, polymers, and laminate structures of glass, polymers or combinations thereof. Suitable polymers include polycarbonate, acrylonitrile-butadiene-styrene, polysulfones, polyether sulfones, polyarylates, polystyrenes, polyamides, and like polymers. The selection of the light-transparent material is determined by the desired application.

The light-transparent component 12 may transmit light having a wavelength of about 200 to about 800 nm. Preferably, the light transparent component 12 is selected to transmit light having wavelengths of about 300 to about 750 nm, with about 400 to about 750 nm even more preferred. In a preferred embodiment, the light-transparent component 12 allows transmission of light within the absorption and emission spectrum of light. In this embodiment, the light-transparent component 12 may transmit radiant energy to the phosphorescent material 14 causing excitation of electrons of the phosphorescent material 14 as well as transmit light emitted by the phosphorescent material 14. In a preferred embodiment, the light-transparent component 12 transmits light within the blue portion of the visible spectrum, i.e., about 350 to about 450 nm.

As the sunroof panel 10 is exposed to a light source, the light-transparent component 12 transmits the radiant energy from the light source to the phosphorescent material 14 located on the surfaces 18 and/or 20 of the light-transparent component 12 and/or disposed within a matrix of the light-transparent component 12. The phosphorescent material 14 may be applied as a coating 22,24 such as a film or layer on at least one surface 18,20 of the light-transparent component 12. In this embodiment, the phosphorescent material 14 may be cast in a suitable binder or in a solvent to form the coating 22, 24. In yet another embodiment, also illustrated in FIG. 1, the phosphorescent material 14 may be dispersed within the light transparent component 12 in combination with one or more coating 22, 24. The placement of the phosphorescent material 14 may be determined by the desired application.

The phosphorescent material 14 absorbs a portion of the radiant energy from the light source causing excitation of electrons within the phosphorescent material 14. As the electrons fall back to their original energy levels, i.e., decay, they release energy in the form of visible light. Suitable external light sources for exciting the phosphorescent material 14 include the sun, streetlights, headlamps, and the like. In addition to absorbing radiant energy from the external light source, the phosphorescent material 14 may cause scattering of the light, thereby diffusing the light. In this manner, the phosphorescent material 14 may advantageously reduce the heat load and the amount of direct radiation into the interior portion 30 of a vehicle. The reduction in heat load may provide energy saving benefits by reducing the dependency on air conditioning to maintain a comfortable atmosphere in the interior of the vehicles.

Upon excitation, the phosphorescent material 14 may emit light in the direction of the surfaces 18 and/or 20 to an area beyond the sunroof panel 10, and/or out an edge 25, 26, 27, 29 of the sunroof panel 10.

As previously described and shown in FIG. 2, the phosphorescent material 14 may be dispersed within a matrix of the light-transparent component 12. For example, the phosphorescent material 14 may be dispersed within a polymer material that is employed during fabrication of a plastic sunroof panel 10 or is used as one of the layers in a laminate sunroof panel 10. In glass sunroof panels, the phosphorescent material 14 may be added directly to forming or heated glass during fabrication thereof. The choice and type of light-transparent materials as well as processes of sunroof manufacture are known to those skilled in the art.

The phosphorescent material 14 is chosen from materials known to those skilled in the art. Exemplary phosphorescent materials 14 include, but are not limited to, non-oxide phosphors such as zinc sulfide phosphors, which may become excited quickly to attain maximum brightness. Zinc sulfides generally exhibit a glow light discharge for shorter periods of time than other phosphors. A zinc sulfide composition may be doped with at least one transition metal or rare earth metal to enhance photoluminescence excitation. For example, zinc sulfide doped with copper metal, i.e., ZnS:Cu, may require only a few seconds of ultraviolet or incident light exposure to provide a glow light discharge. Other zinc sulfide compositions may be configured to provide a glow light discharge with a particular hue. For instance, zinc sulfide doped with silver metal, i.e., ZnS:Ag, may provide a blue glow light discharge. Zinc sulfide doped with manganese metal, i.e., ZnS:Mn, may provide a green glow light discharge. These and other zinc sulfide compositions are known to those skilled in the art to provide a glow light discharge in response to photoluminescence excitation.

Other phosphors include long decay time phosphors such as oxide phosphors including, but not limited to, oxide ceramic phosphors. As in the zinc sulfide compositions, oxide ceramic phosphors may be doped, such as with a rare earth metal. These types of phosphors generally exhibit a long decay time. For example, an alkaline-earth metal oxide aluminate material may have longer glow light discharge time after exposure to radiant energy of the appropriate wavelength. These phosphors may be exposed to light for longer periods of time to achieve excitation to provide a longer and brighter glow light discharge relative to non-oxide phosphors. A typical alkaline-earth oxide aluminate may provide a glow light discharge still visible after about 24 hours. Suitable examples of non-oxide phosphors include, but are not intended to be limited to, strontium oxide aluminate doped with europium, strontium oxide aluminate doped with europium and dysprosium, and the like. Other suitable compositions are known to those skilled in the art, and the selection of type, amount, and location of the oxide phosphors is determined by the desired application.

In another embodiment, the phosphorescent material 14 contains more than one type of phosphor. One of the phosphors preferably comprises a phosphor having a long decay time such as the alkaline-earth oxide aluminate material described above, and at least one of the other phosphors preferably comprises a relatively shorter decay time, for example the zinc sulfide type phosphors. Less than an hour of daylight exposure may effectively excite the various phosphors comprising the phosphorescent material 14 to cause the phosphorescent material 14 to provide a continuous glow light discharge for many hours. The different types of phosphors may be combined in such a way that a predetermined pattern is visible when the phosphors are excited, as shown by the star pattern 28, in FIG. 1. In additional embodiments, phosphors may be combined as to type and amount to provide desired visibility or aesthetic patterns. Phosphors may be chosen as to type and concentration to produce a shading effect, distributing a glow to specific areas within the vehicle. The phosphorescent material 14 may be coated or dispersed within the matrix of the light-transparent component 12 to provide a variety of configurations and glow hues as determined by the desired application.

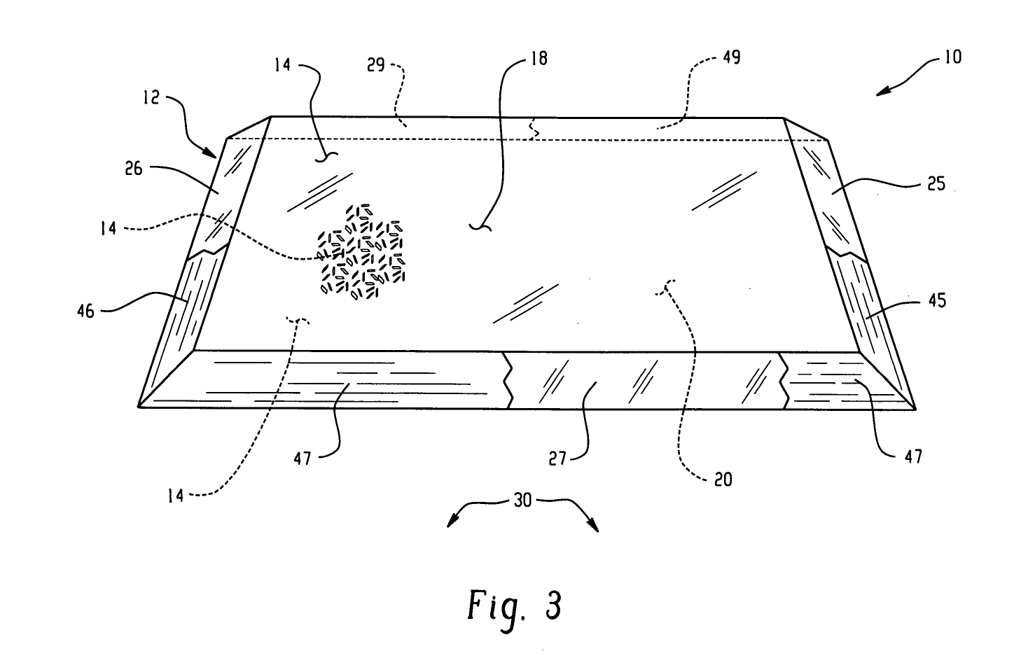

Turning now to FIG. 3, a view of an edge 26 of the sunroof panel 10 is illustrated. The sunroof panel 10 comprises light-transparent material 12 and phosphorescent material 14. The phosphorescent material 14 may be dispersed within the light-transparent component 12 and/or applied as a coating 22, 24 to one or more surface 18,20 of the light-transparent component 12. In one embodiment, the edge 26 preferably has a form and dimension that allows the edge 26 to reflect light. Generally, an edge 26 that is angularly cut may provide the desired light reflection. In this manner, light exposed to the sunroof panel and the phosphorescent material 14 disposed therein and/or thereon may transmit and/or scatter the light to the edge 26. As a result, depending on the design of the edge 26, the light not absorbed by the phosphorescent material or the light-transparent component, can be reflected at the edge back into the interior of the vehicle. The form and dimensions of the edge 26 will be determined by the desired application.

In another embodiment, the edge 26 comprises a reflecting material 46 disposed thereon to reflect the scattered light back into the interior 30 of the vehicle. The types of reflecting material are known to those skilled in the art including those materials known to mirror light. Additional embodiments include more than one edge 25, 26, 27, 29 capable of reflecting light. Optionally, the edge 25, 26, 27, 29 may comprise a reflecting material 45, 46, 47, 49 to reflect light back in the direction of the interior 30 of the vehicle

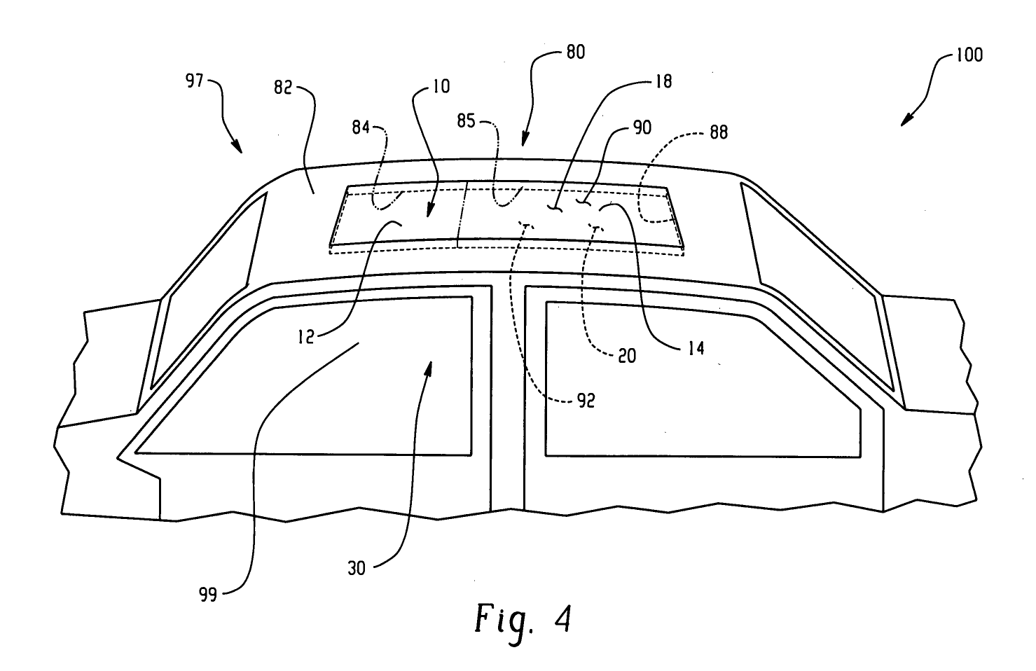

In FIG. 4, a simplified schematic of a vehicle sunroof assembly 80 is shown. The vehicle sunroof assembly 80 includes a vehicle roof 82 having an opening 84 extending between an exterior portion 97 and interior portion 30 of a vehicle 100 and a sunroof panel 10 adapted to fit the opening 84. The sunroof panel 10 comprises the light-transparent material 12 comprising at least one surface 18, 20 and the phosphorescent material 14 as previously described. The phosphorescent material 14 may be dispersed within the matrix of the light transparent component 12 or disposed on at least one surface 18, 20 of the light-transparent component 12. The sunroof panel 10 may be of any of a variety of shapes such as circular, rectangular or other acceptable shape that fits the dimensions of the roof opening 84. The roof opening 84 may be of a shape and dimension which exposes the sunroof panel 10 to external light shining from a desirable point outside the roof 82 including incident light from headlamps of other vehicles.

In another embodiment, a sunroof assembly may comprise a plurality of openings, e.g., 84, 85. The sunroof panel 10 is in communication with the interior surface 88 of the opening 84 of the roof 82. The sunroof panel 10 communicates with the interior surface 88 by any method known in the art that provides the desired application of the sunroof assembly 80. The sunroof panel further comprises an exterior surface 90 and an interior surface 92.

As shown in this view, radiant light energy from an external light source shines on the exterior surface 90 of the sunroof panel 10. As the light passes through the light-transparent material 87, a portion of the light passes directly through to the interior surface 92 of the sunroof panel 10 and into an interior portion 30 of a vehicle 100 such as a passenger compartment 99. The phosphorescent material 14 absorbs a portion of the radiant energy. The phosphorescent material 14 of the sunroof panel 10 is excited by the radiant energy and slowly decays, causing the phosphorescent material 89 to provide a glow light discharge for a period of time following exposure to and absorption of the radiant energy. In addition, the phosphorescent material 89 may scatter the radiant energy entering the sunroof panel 10, thereby diffusing the light that enters into the interior portion 30 of the vehicle 100.

Advantageously, a phosphorescent sunroof of the present invention provides a light scattering medium that may diffuse light transmission into a vehicle thereby reducing radiation and heat load within the vehicle. A phosphorescent material containing phosphors of varying decay time may be excited by the light, causing the phosphors to glow and provide enhanced visibility within the vehicle while maintaining privacy of the passengers within the vehicle. The time period of the glow light discharge may provide a secondary light source in the absence of an external light source, such as at night.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to a particular embodiment disclosed as the best mode contemplated for carrying out this invention, but that the invention will include all embodiments falling within the scope of the appended claims.

1-12. (canceled)

13. A vehicle sunroof assembly, comprising:
a vehicle roof portion having at least one opening, said opening extending between an interior portion and an exterior portion of the vehicle roof portion; and
a sunroof panel adapted to fit the at least one opening, said panel comprising an inorganic phosphorescent material and a light-transparent component, wherein the inorganic phosphorescent material is dispersed within a matrix of the light-transparent component.

14-15. (canceled)

16. The vehicle sunroof assembly according to claim 13, wherein the inorganic phosphorescent material comprises a non-oxide phosphor, an oxide phosphor, or a combination comprising at least one of the foregoing inorganic phosphorescent materials.

17. The vehicle sunroof assembly according to claim 16, wherein the non-oxide phosphor is selected from a group consisting of zinc sulfide, zinc sulfide doped with a transition metal, and zinc sulfide doped with a rare earth metal.

18. The vehicle sunroof assembly according to claim 16, wherein the oxide phosphor is selected from a group consisting of an oxide ceramic phosphor, an oxide ceramic phosphor doped with an alkaline earth metal, and an oxide ceramic phosphor doped with a rare earth metal.

19. A method for providing light into an interior of a vehicle, comprising:
exposing a panel disposed in an opening of the vehicle to an external light source, wherein the panel comprises a phosphorescent material and a light-transparent component wherein the phosphorescent material is dispersed within a matrix of the light-transparent component;
absorbing radiant energy from the external light source to excite electrons in the phosphorescent material; and
emitting visible light from the phosphorescent material and into the interior portion of the vehicle upon exposure to the external light source or upon discontinuation of the external light source.

20. The method according to claim 19, further comprising diffusing the radiant energy produced from the external light source with the phosphorescent material to reduce radiation and heat load into the vehicle.
